(19) United States
(12) Patent Application Publication
(10) Pub. No.: US 2002/0182085 A1
(43) Pub. Date: Dec. 5, 2002

(54) Power transmitting mechanism

(76) Inventors: Takeshi Kawata, Kariya-shi (JP); Masahiro Kawaguchi, Kariya-shi (JP); Masaki Ota, Kariya-shi (JP); Taku Adaniya, Kariya-shi (JP); Akinobu Kanai, Kariya-shi (JP); Takahiro Suzuki, Kariya-shi (JP)

Correspondence Address: MORGAN & FINNEGAN, L.L.P., 345 Park Avenue, New York, NY, 10154, US

(21) Appl. No.: 10/162,369

(22) Filed: Jun. 3, 2002

(30) Foreign Application Priority Data
Jun. 4, 2001 (JP) 2001-168606

(51) Int. Cl. F16D 7/04; F04B 35/00

(52) U.S. Cl. 417/212

(57) ABSTRACT

A power transmitting mechanism has a first rotary body and a second rotary body. The first rotary body has a plurality of first elastic members. The first elastic members are layered. The second rotary body is arranged coaxially with the first rotary body, and has an engaging portion for engaging with the layered first elastic members to permit power transmission between the first rotary body and the second rotary body. The coefficient of elasticity of the layered first elastic members continuously varies with a relative rotational angle between the first rotary body and the second rotary body.

The present invention relates to a power transmitting mechanism that transmits torque of a first rotary body of a drive device to a second rotary body of a driven device.

Japanese Unexamined Patent Publication No.10-267047 discloses a power transmitting mechanism of such type. In the prior art, a boss located coaxially with a pulley pivotally supports a turn pawl. A fixed pawl of the pulley engages with the turn pawl so as to permit torque transmission between the fixed pawl and the turn pawl.

The turn pawl is pressed against the fixed pawl by a plate spring mounted on the boss. As constructed above, when the excessive torque is applied between the pulley and the boss, the turn pawl pivots against the elastic force of the plate spring. Thereby, the turn pawl disengages from the fixed pawl. Consequently, power transmission between the pulley and the boss is blocked. Then, the turn pawl is held at a retreated position, where the turn pawl cannot engage with the fixed pawl, by pressing force due to the plate spring. Thereby, the turn pawl is inhibited from re-engaging with the fixed pawl.

An unwanted effect is that, in the above-constructed power transmitting mechanism, the plate spring only enables to limit transmission torque repeatedly. The plate spring has not been configured to check resonance. Therefore, it is desired that resonance upon the power transmission is inhibited.

### SUMMARY OF THE INVENTION

In accordance with the present invention, a power transmitting mechanism has a first rotary body and a second rotary body. The first rotary body has a plurality of first elastic members. The first elastic members are layered. The second rotary body is arranged coaxially with the first rotary body, and has an engaging portion for engaging with the layered first elastic members to permit power transmission between the first rotary body and the second rotary body. The coefficient of elasticity of the layered first elastic members continuously varies with a relative rotational angle between the first rotary body and the second rotary body.

The present invention also provides a power transmitting mechanism having a first rotary body and a second rotary body. The first rotary body has a plurality of elastic members, each of which has a first engaging portion, which is projection or recess. The second rotary body is arranged coaxially with the first rotary body, and has a second engaging portion, which is recess or projection. The second engaging portion engages with the first engaging portion to permit power transmission between the first rotary body and the second rotary body. The first engaging portion is configured so as to change its position relative to the first rotary body in accordance with deformation of the elastic members due to transmission torque between the first rotary body and the second rotary body, thereby permitting the first rotary body and the second rotary body to rotate relative to each other in accordance with the engaging projection of one of the first engaging portion and the second engaging portion sliding along a sliding surface of the engaging recess of the other of the first engaging portion and the second engaging portion. The number of the operative elastic members increases when the value of a relative rotational angle between the first rotary body and the second rotary body exceeds a predetermined value. Variation in the transmission torque continuously varies with variation in the relative rotational angle.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a cross-sectional view of a variable displacement compressor having a power transmitting mechanism according to a first embodiment of the present invention;

FIG. 2A is an end view of a pulley and a receiving member of the power transmitting mechanism according to the first embodiment of the present invention;

FIG. 2B is a partially cross-sectional view, taken along the line I-I in FIG. 2A;

FIG. 3 is a partially enlarged view of a pair of layered plate springs, an engaging projection and an engaging recess in a non-power transmitted state according to the first embodiment of the present invention;

FIG. 4 is a partially enlarged view of the pair of layered plate springs, the engaging projection and the engaging recess in a power-transmitted state according to the first embodiment of the present invention;

FIG. 5 is a partially enlarged view of a pair of layered plate springs, an engaging projection and an engaging recess according to another embodiment of the present invention;

FIG. 6 is an explanatory view of an operation of one of the layered plate springs according to the first embodiment of the present invention;

FIG. 7 is a graph showing a characteristic curve C1 of a load torque as a function of a relative rotational angle according to the first embodiment of the present invention;

FIG. 8A is an end view of a pulley and a receiving member of a power transmitting mechanism according to a second embodiment of the present invention;

FIG. 8B is a partially cross-sectional view, taken along the line II-II in FIG. 8A;

FIG. 9 is an end view of the pulley and the receiving member of the power transmitting mechanism according to the second embodiment of the present invention;

FIG. 10 is a graph showing a load torque as a function of a relative rotational angle according to the second embodiment of the present invention;

FIG. 11 is an end view of the pulley and the receiving member of the power transmitting mechanism according to the second embodiment of the present invention;

FIG. 12 is a partial end view of the pulley with a roller and the receiving member with a second power transmitting arm and according to the second embodiment of the present invention;

FIG. 13 is an end view of a pulley and a receiving member according to another embodiment of the present invention;

FIG. 14 is an end view of a pulley and a receiving member according to another embodiment of the present invention; and

FIG. 15 is an end view of a pulley and a receiving member according to another embodiment of the present invention.

### DETAILED DESCRIPTION OF THE PREFERRED EMBODIMENTS

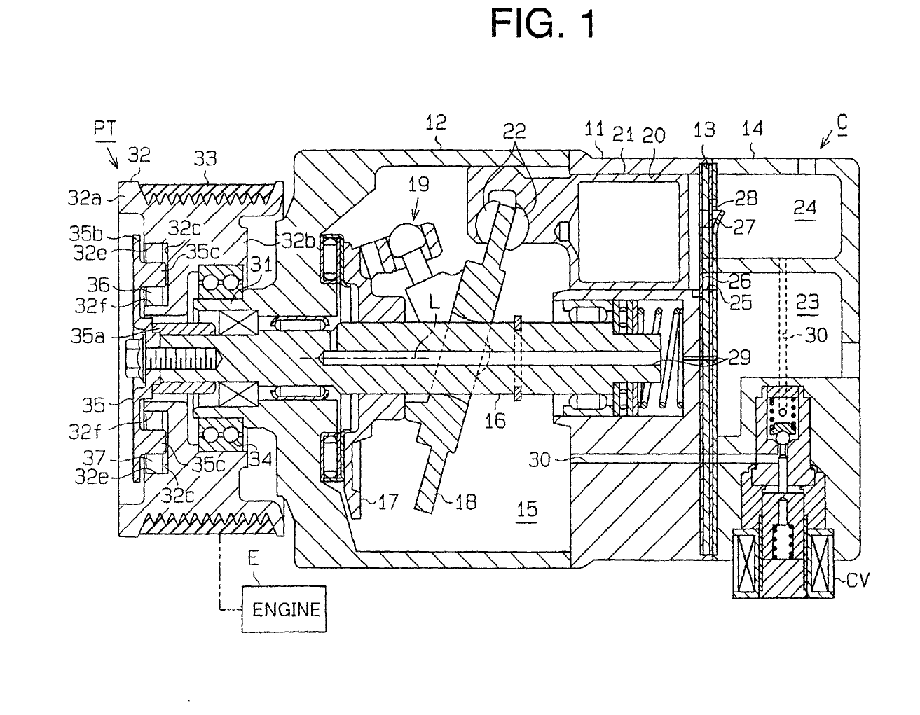

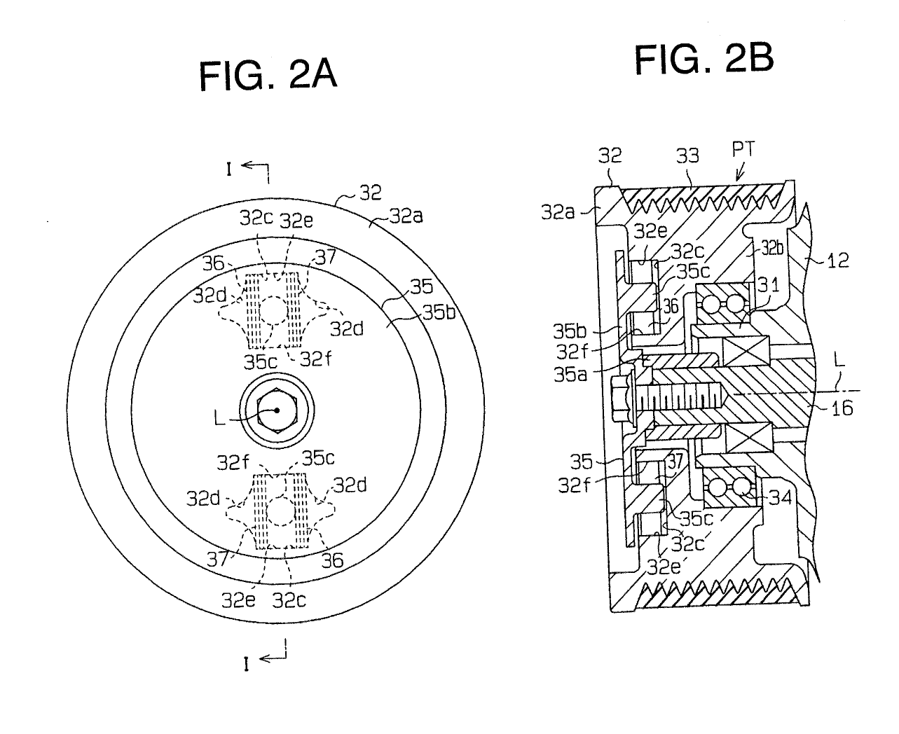

A first embodiment of the present invention will now be described with reference to FIGS. 1 to 4, 6 and 7. The left side and the right side correspond to the front side and the rear side in FIGS. 1 and 2B, respectively.

As shown in FIG. 1, the variable displacement compressor C has a cylinder block 11, a front housing 12, a valve plate assembly 13 and a rear housing 14. The front housing 12 connects with the front end of the cylinder block 11. The rear housing 14 connects with the rear end of the cylinder block 11 through the valve plate assembly 13. The cylinder block 11, the front housing 12 and the rear housing 14 constitute a housing of the compressor C.

A crank chamber 15 is defined between the cylinder block 11 and the front housing 12. A drive shaft 16 extends through the crank chamber 15, and is rotatably supported by the housing. A lug plate 17 is secured to the drive shaft 16 to rotate integrally with the drive shaft 16.

The front end of the drive shaft 16 connects with a vehicular engine E or an external drive source through a power transmitting mechanism PT. The crank chamber 15 accommodates a swash plate 18. The swash plate 18 is supported to slide along the drive shaft 16 and to incline with respect to the drive shaft 16. A hinge mechanism 19 is located between the lug plate 17 and the swash plate 18. Thereby, the swash plate 18 integrally rotates with the lug plate 17 and the drive shaft 16 through the hinge mechanism 19, and inclines with respect to the drive shaft 16 while sliding along the drive shaft 16 in the direction of the axis L of the drive shaft 16.

A plurality of cylinder bores 20 (only one is shown in FIG. 1) is bored through the cylinder block 11 and is located around the drive shaft 16. Each of the cylinder bores 20 accommodates a single-headed piston 21 so as to reciprocate. Front and rear openings of each of the cylinder bores 20 are closed by the valve plate assembly 13 and the piston 21. A compression chamber is defined in each of the cylinder bores 20a. The volume of each compression chamber varies with reciprocation of the associated piston 21. Each piston 21 engages with the outer periphery of the swash plate 18 through a pair of shoes 22. Thereby, rotation of the swash plate 18 is converted to reciprocation of each piston 21.

A suction chamber 23 and a discharge chamber 24 are defined between the valve plate assembly 13 and the rear housing 14. Corresponding to each of the cylinder bores 20, the valve plate assembly 13 forms a suction port 25 and a suction valve 26, which selectively opens and closes the suction port 25, and also forms a discharge port 27 and a discharge valve 28, which selectively opens and closes the discharge port 27. The suction chamber 23 connects with the cylinder bores 20 through respective suction ports 25. The discharge chamber 24 connects with the cylinder bores 20 through respective discharge ports 27.

When each piston 21 moves from a top dead center toward a bottom dead center, refrigerant gas flows from the suction chamber 23 into the cylinder bores 20 through respective suction ports 25 by pushing the suction valve 26 aside. When the piston 21 moves from the bottom dead center toward the top dead center, refrigerant gas is compressed to a predetermined pressure value in the cylinder bores 20, and is discharged to the discharge chamber 24 through respective discharge ports 27 by pushing the discharge valve 28 aside.

In the compressor C, the pressure in the crank chamber 15 is varied due to an electromagnetic control valve CV. Thereby, the inclination angle of the swash plate 18 is adjusted to a certain inclination angle between the maximum inclination angle (a state shown in FIG. 1) and the minimum inclination angle. Besides, when the inclination angle of the swash plate 18 relative to the plane perpendicular to the axis L is the closest to 90°, the inclination angle then is minimum. When the swash plate 18 inclines to the maximum remote from the minimum inclination angle, the inclination angle then is maximum.

The crank chamber 15 connects with the suction chamber 23 through a bleed passage 29. The discharge chamber 24 connects with the crank chamber 15 through a supply passage 30. The electromagnetic control valve CV is located in the supply passage 30. A controller, which is not shown in the drawings, adjusts the opening degree of the control valve CV to adjust the amount of high-pressure refrigerant gas flowed from the discharge chamber 24 to the crank chamber 15 through the supply passage 30. The pressure in the crank chamber 15 is determined based on a balance between the amount of refrigerant gas flowing into the crank chamber 15 and the amount of refrigerant gas flowing from the crank chamber 15 to the suction chamber 23 through the bleed passage 29. As the pressure in the crank chamber 15 varies, pressure differential applied to the piston 21 between the crank chamber 15 and the cylinder bores 20 varies. Thereby, the inclination angle of the swash plate 18 varies, with a consequence of the stroke of each piston 21, or the displacement of the compressor, is adjusted.

As shown in FIGS. 1 and 2, a support cylinder 31 extends from the front end of the front housing 12, and surrounds the front end of the drive shaft 16. A pulley 32, or a first rotary body, includes a cylindrical belt receiving portion 32a and an annular base portion 32b. A belt 33 connects with an output shaft of the engine E, and winds around the belt receiving portion 32a. The base portion 32b extends radially inward from the inner side of the belt receiving portion 32a. The support cylinder 31 rotatably supports the pulley 32 through a bearing 34 at the base portion 32b. The pulley 32 is located coaxially with the drive shaft 16 around the axis L, and rotates relative to the drive shaft 16.

A receiving member 35, or a second rotary body, is secured to the front end of the drive shaft 16, and integrally rotates with the drive shaft 16. The receiving member 35 includes a cylindrical member 35a and a disk-shaped hub 35b. The cylindrical member 35a is fitted around the front end of the drive shaft 16. The hub 35b engages with the front end of the cylindrical member 35a. A structure such as a spline engagement structure and a key structure engages the drive shaft 16 with the cylindrical member 35a, and also engages the cylindrical member 35a with the hub 35b. Thereby, the drive shaft 16, the cylindrical member 35a and the hub 35b can rotate integrally.

A plurality of cylindrical engaging projections 35c (two in the present embodiment) is integrally formed on the rear end of the hub 35b in equiangular positions (in every 180° in the present embodiment) so as to extend rearward in the direction of the axis L.

The base portion 32b of the pulley 32 faces the rear end of the receiving member 35, and forms recesses 32c to correspond to the engaging projections 35c. The recesses 32c respectively accommodate the engaging projections 35c.

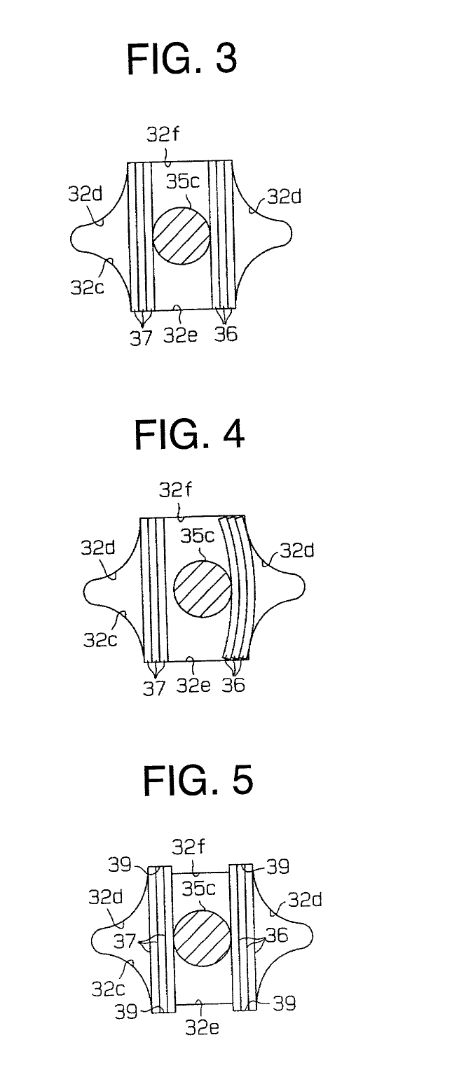

As shown in FIGS. 2A and 3, the shape of each recess 32c is formed symmetrically with respect to a hypothetical line (not shown in the drawings), which extends radially from the center of the pulley 32, as seen from the front end of the pulley 32 in the direction of the axis L. A pair of inner wall surfaces 32d constituting a part of inner wall surface of each recess 32c faces each other in the circumferential direction of the pulley 32, and is curved from each radial end toward the radial middle of the recess 32c so as to expand a space between the pair of inner wall surfaces 32d.

A plurality of plate springs 36 (three in the present embodiment) or elastic members, which is layered, is arranged in each recess 32c to align in the circumferential direction of the pulley 32. Each plate spring 36 is made of the same material, and is the same shape.

Also, the same number of other plate springs 37 (three in the present embodiment), which are layered, is arranged in each recess 32c to align in the circumferential direction of the pulley 32 at the opposite side of the layered plate springs 36 relative to a hypothetical line (not shown in the drawings), which extends from the center of the pulley 32 toward the center of each recess 32c. Each plate spring 37 respectively is made of the same material and is the same shape as the plate spring 36.

When unloaded, each end of the layered plate springs 36 and 37 substantially abuts against an outside inner wall surface 32e and an inside inner wall surface 32f, which face each other in the radial direction of the pulley 32. The outside inner wall surface 32e and the inside inner wall surface 32f constitute the part of inner wall surface of each recess 32c.

Each engaging projection 35c is inserted into respective recess 32c, and is located between the layered plate springs 36 and the layered plate springs 37. Namely, each engaging projection 35c can engage with each recess 32c in a manner that the each engaging projection 35c directly abuts against the layered plate springs 36 and 37.

The receiving member 35 connects with the pulley 32 so as to rotate relatively in a predetermined angle range by engaging each engaging projections 35c with the layered plate springs 36 and 37. Thereby, power transmission (torque transmission) from the pulley 32 to the receiving member 35 is permitted.

When power is not transmitted from the pulley 32 to the receiving member 35, each middle of the layered plate springs 36 and 37 adjacent to the engaging projection 35c abuts against the engaging projection 35c, and each end of the layered plate springs 36 and 37 adjacent to respective inner wall surfaces 32d abuts against each end of the inner wall surfaces 32d adjacent to the inside inner wall surface 32e and adjacent to the outside inner wall surface 32f, respectively. In such a state, each middle of the layered plate springs 36 and 37 slightly elastically deforms outward, that is, elastically deforms from the engaging projection 35c toward respective inner wall surface 32d, and both the layered plate springs 36 and 37 urge the engaging projection 35c in the circumferential direction of the pulley 32. Additionally, the urging forces pressing against the engaging projection 35c by the layered plate springs 36 and 37 are substantially equal, and are balanced.

In the present embodiment, power transmitted from the engine E to the pulley 32 through the belt 33 is transmitted to the receiving member 35 through the layered plate springs 36 and the engaging projections 35c, and then to the drive shaft 16 of the compressor C.

In a state that power is not transmitted from the pulley 32 to the receiving member 35, such as upon a stop of the engine E, and when the pulley 32 starts to rotate in a predetermined direction, which is a clockwise direction in FIG. 2A, the amount of elastic deformation of the layered plate springs 36 starts to increase due to the force pressed by the engaging projections 35c. As a load torque T applied between the pulley 32 and the receiving member 35 upon the power transmission increases, the amount of elastic deformation of the layered plate springs 36 increases and a relative rotational angle θ between the pulley 32 and the receiving member 35 increases. Additionally, when the relative rotational angle θ increases and reaches a certain value, the layered plate springs 37 returns to an unloaded state. In such a state, as the relative rotational angle θ further increases, the layered plate springs 37 adjacent to the engaging projection 35c separates from the engaging projection 35c, as shown in FIG. 4.

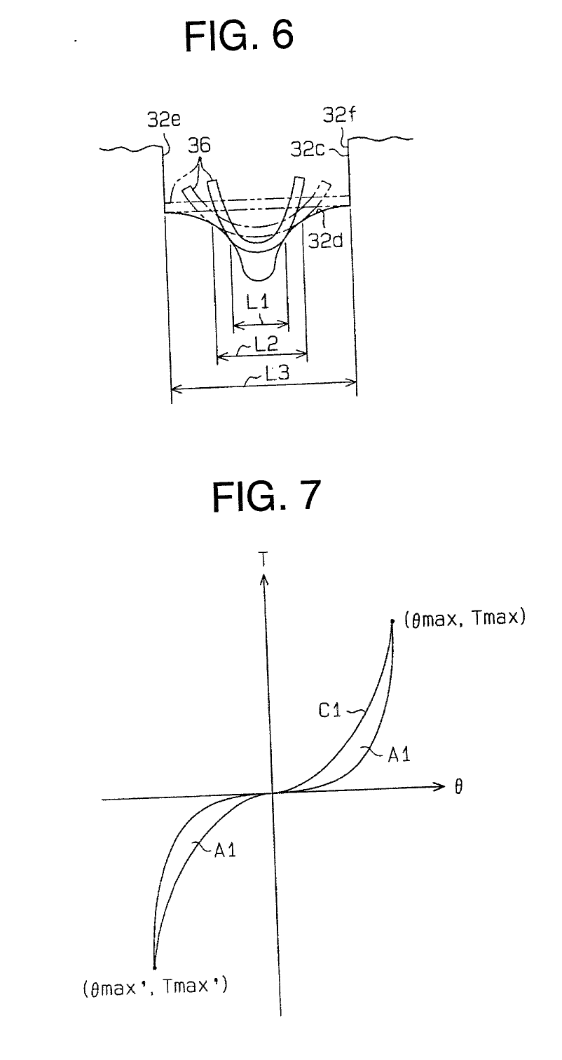

In the present embodiment, the coefficient of elasticity of the layered plate springs 36 is configured to vary with the amount of elastic deformation of the layered plate springs 36. The mechanism will now be described with reference to FIG. 6. FIG. 6 illustrates one of the layered plate springs as a bilateral support plate spring.

As shown in FIG. 6, the inner wall surface 32d supporting both ends of the plate spring 36 is curved from each end toward its middle so as to be farther from the unloaded plate spring 36 (illustrated by a two-dotted line).

Pressed by the engaging projection 35c (not shown in FIG. 6), the middle of the plate spring 36 elastically deforms so as to be pushed into a middle recess of the inner wall surface 32d from the upper side toward the lower side in FIG. 6. Then, distances L1 and L2 between the support points of the elastically deformed plate spring 36 (illustrated respectively by a solid line and a dotted line) become shorter than a distance L3 between the support points of the unloaded plate spring 36. Besides, the inner wall surface 32d supports the plate spring 36 at the support points. Namely, as the force pressing against the plate spring 36 into the middle recess of the inner wall surface 32 by the engaging projection 35c increases, the distance between the support points reduces.

The coefficient of elasticity of the plate spring 36, which is a bilateral support spring, is inversely proportional to the cubic of the distance between the support points. Namely, the force pushing the plate spring 36 into the middle recess of the inner wall surface 32 by the engaging projection 35c increases, the coefficient of elasticity of the plate spring 36 increases. The amount of depth pushing the plate spring 36 into the middle recess by the engaging projection 35c is substantially directly proportional to the relative rotational angle θ as far as the relative rotational angle θ is relatively small. Therefore, the coefficient of elasticity of the plate spring 36 continuously varies with the relative rotational angle θ.

In the pulley 32 of the present embodiment, the layered plate springs 36 and the layered plate springs 37 are configured as the same. Thereby, even if the pulley 32 rotates in each direction, the power transmission from the pulley 32 to the receiving member 35 is permitted. Besides, the layered plate springs 37 also function as an urging means for urging the engaging projection 35c toward the layered plate springs 36.

As shown in FIG. 7, when power is not transmitted, the value of the relative rotational angle θ and the value of the load torque T are zero. In such a state, the value of the relative rotational angle θ increases in the regular direction, the value of the load torque T increases to the regular maximum permissible load torque Tmax due to the function of the layered plate springs 36 nonlinearly to the relative rotational angle θ. Also, when the value of the load torque T is the regular maximum permissible load toque Tmax, the value of the relative rotational angle θ between the pulley 32 and the receiving member 35 becomes the regular maximum relative rotational angle θ max. In such a state, as the value of the relative rotational angle θ reduces, the value of the load torque T reduces nonlinearly, and the value of the load torque T relative to the relative rotational angle θ indicates a different characteristic from that upon increasing due to hysteresis arisen from friction generated between the layered plate springs 36. Namely, a characteristic curve C1 defines a closed area A1.

Also, in the present embodiment, when the pulley 32 rotates relative to the receiving member 35 in the reverse direction (the counterclockwise direction in FIG. 2A), the value of the load torque T as a function of the relative rotational angle θ indicates a similar characteristic curve, which is congruous to the characteristic curve C1 when rotating with respect to the origin of FIG. 7 at an angle of 180 degrees, due to the function of the layered plate springs 37. Namely, in a state that power is not transmitted, the value of the relative rotational angle θ increases in the reverse direction due to reverse rotation of the pulley 32, the value of the load torque T increases to the reverse maximum permissible load torque Tmax′ nonlinearly to the relative rotational angle θ. Also, when the value of the load torque T is the reverse maximum permissible load toque Tmax′, the value of the relative rotational angle θ between the pulley 32 and the receiving member 35 becomes the reverse maximum relative rotational angle θ max′. In such a state, as the value of the relative rotational angle θ reduces toward the origin, the value of the load torque T nonlinearly varies, and indicates a different characteristic curve from that upon increasing due to the hysteresis. Namely, the characteristic curve C1 also defines another closed area A1. Additionally, the absolute value of the regular maximum permissible load torque Tmax equals that of the reverse maximum permissible load torque Tmax′, and the absolute value of the regular maximum relative rotational angle θ max equals that of the reverse maximum relative rotational angle θmax′.

The following advantageous effects are obtained from the present embodiment.

(1) The coefficient of elasticity of the layered plate springs 36, which are located in a power transmitting path between the pulley 32 and the receiving member 35, is configured to continuously vary with the relative rotational angle θ between the pulley 32 and the receiving member 35. Thereby, resonance between the pulley 32 and the receiving member 35 is inhibited.

(2) The plurality of plate springs 36 is layered. Thereby, durability of the plate springs improves as compared with a plate spring having the same thickness as the total thickness of the plurality of plate springs 36. Also, since the plate springs 36 are employed as the elastic member, the elastic member is easily manufactured.

(3) The distance between the support points of the layered plate springs 36 is configured to vary with the relative rotational angle θ when the layered plate springs 36 deform upon engaging with the engaging projection 35c. Thereby, the coefficient of elasticity of the layered plate springs 36 continuously varies with the relative rotational angle θ.

(4) The layered plate springs 37 are also located at the opposite side of the plate springs 36 relative to the engaging projection 35c. Thereby, the pair of layered plate springs is located on each side of the engaging projection 35c in the circumferential direction of the pulley 32. Namely, in such a state, the power transmission and inhibition of resonance in the regular and reverse rotational directions are performed. Therefore, the power transmitting mechanism works regardless of the rotational direction of a drive source. Also, since the engaging projection 35c is urged toward the layered plate springs 36 by the layered plate springs 37, the engaging projection 35c rarely separates from the layered plate springs 36. Accordingly, the layered plate springs 36 and the engaging projection 35c almost continuously inhibit resonance therebetween.

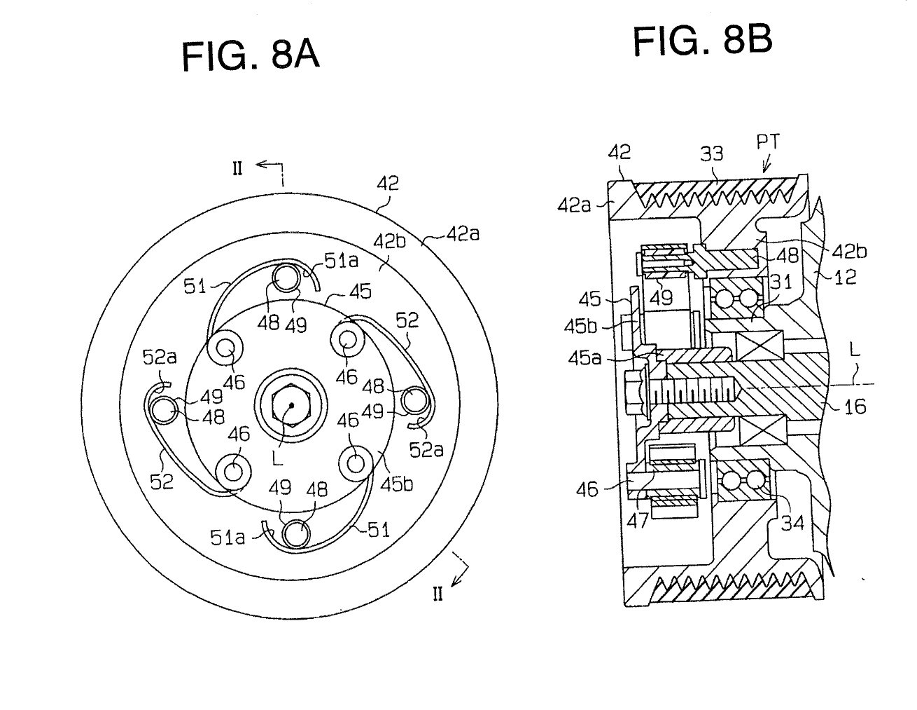

A second embodiment of the present invention will now be described with reference to FIGS. 8A to 12. The left side and the right side correspond to the front side and the rear side in FIG. 8B, respectively. The pulley 32 and the receiving member 35 in the first embodiment are modified in the second embodiment. The components other than the pulley 32 and the receiving member 35 are similar to those in the first embodiment. The same reference numerals denote the similar components in figures.

As shown in FIG. 8A and 8B, a pulley 42 or a second rotary body includes a cylindrical belt receiving portion 42a and an annular base portion 42b. The belt 33 winds around the belt receiving portion 42a to transmit power (torque) from an output shaft of the engine E to the pulley 42. The base portion 42b extends radially inward from the inner circumferential surface of the belt receiving portion 42a. The support cylinder 31 rotatably supports the base portion 42b through the bearing 34. The pulley 42 is arranged coaxially with the drive shaft 16 along the axis L, and can rotate relative to the drive shaft 16.

A receiving member 45 or a first rotary body is fixed to the front end of the drive shaft 16 so as to rotate integrally with the drive shaft 16. The receiving member 45 includes a cylindrical member 45a and a disk-shaped hub 45b. The main body of the cylindrical member 45a fixedly fits around the front end of the drive shaft 16. The hub 45b fits on the front end of the cylindrical member 45a. A structure such as a spline engagement structure and a key structure engages the drive shaft 16 with the cylindrical member 45a, and also engages the cylindrical member 45a with the hub 45b. Thereby, the drive shaft 16, the cylindrical member 45a and the hub 45b can rotate integrally.

A plurality of support pins 46 or support portions (four in the present embodiment) is fixed to the rear outer portion of the hub 45b, and is located around the axis L at predetermined intervals (90 degrees in the present embodiment). A cylindrical sleeve 47 is press-fitted into each support pin 46 by appropriate force. When each sleeve 47 receives certain strength of rotational force, each sleeve 47 rotates relative to the respective support pin 46.

A plurality of engaging pins 48 (four in the present embodiment) is fixed to the front end of the base portion 42b of the pulley 42, and is located around the axis L at predetermined intervals (90 degrees in the present embodiment). A cylindrical roller 49 or a rolling component is rotatably supported by respective engaging pin 48. The engaging pins 48 and the rollers 49 constitute a second engaging portion (or projection). The rollers 49 are located outward from the sleeves 47 of the hub 45b (outer side of the pulley 42).

First power transmitting arms 51 and second power transmitting arms 52, which are elastic members made of plate springs, are alternately located to extend between each sleeve 47 and the associated roller 49 at intervals of 90 degrees. The proximal ends of the arms 51 and 52 fixedly wind around the associated sleeves 47. Both the arms 51 and 52 extend from the sleeves 47 toward the associated rollers 49, which are located to dephase from the sleeves 47 in the clockwise direction with respect to the axis L in FIG. 8A.

The distal ends of both the arms 51 and 52 pass by along the outer side of the respective rollers 49 (outer side of the pulley 42), and curve toward the center of the pulley 42 (toward the axis L). Namely, engaging recesses 51a and 52a or first engaging portions are respectively formed at the distal ends of the arms 51 and 52 to accommodate the associated rollers 49. The arms 51 and 52 can respectively engage with the respective rollers 49 through the respective engaging recesses 51a and 52a. The receiving member 45 connects with the pulley 42 so as to rotate relatively in a predetermined angle range, and power (torque) transmission from the pulley 42 to the receiving member 45 is permitted when the arms 51 and 52 engage with the respective rollers 49.

Power transmitted from the engine E to the pulley 42 through the belt 33 is transmitted to the receiving member 45 through the rollers 49 fitted to the pulley 42 and each of the power transmitting arms 51 and 52 engaging with the respective rollers 49, and then to the drive shaft 16 of the compressor C.

In the present embodiment, in a state that power is not transmitted from the pulley 42 to the receiving member 45 such as upon a stop of the engine E, and when the pulley 42 starts to rotate in the clockwise direction in FIG. 8A, only the first power transmitting arms 51 transmit power. Upon the power transmission, the first power transmitting arms 51 (mainly the middle portion of the arm 51) elastically deform due to the respective rollers 49, which engage with the associated engaging recesses 51a. As a load torque T1 applied between the pulley 42 and the receiving member 45 upon the power transmission increases, the amount of elastic deformation of the first power transmitting arms 51 increases, and a relative rotational angle θ 1 between the pulley 42 and the receiving member 45 also increases.

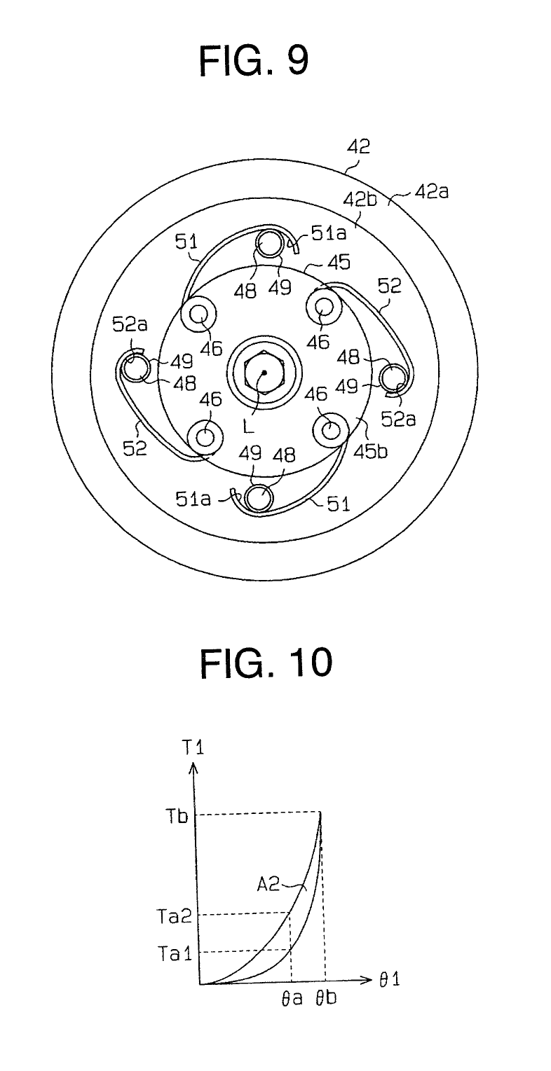

When the load torque T1 increases and reaches a predetermined value, the relative rotational angle θ 1 also reaches a predetermined angle value. Thereby, the engaging recesses 52a of the second power transmitting arms 52 engage with the respective rollers 49, as shown in FIG. 9. Therefore, in addition to the power transmission by the first power transmitting arms 51, the second power transmitting arms 52 transmit power. In such a state, the second power transmitting arms 52 (mainly at the engaging recesses 52a) elastically deform due to the respective rollers 49, which engage with the associated engaging recesses 52a, and the amount of elastic deformation of the first power transmitting arms 51 further increases as compared with the power transmission only by the first transmitting arms 51.

FIG. 10 indicates the value of the load torque T1 applied to an elastic body, which is constituted of both the power transmitting arms 51 and 52, as a function of the relative rotational angle θ 1 between the pulley 42 and the receiving member 45.

In FIG. 10, the relative rotational angle θ 1 is defined to start from a state that the pulley 42 and the receiving member 45 are arranged such that the rollers 49 engage with the respective engaging recesses 51a and the first power transmitting arms 51 are not deformed by the respective rollers 49 (the load torque is not applied between the pulley 42 and the receiving member 45).

An angle value θ a in FIG. 10 indicates the predetermined angle value, where the power transmission only by the first power transmitting arms 51 and the power transmission by both the power transmitting arms 51 and 52 switch to each other.

In the present embodiment, hysteresis due to friction generated between the engaging pins 48 and the rollers 49 arises between the load torque T1 and the relative rotational angle θ 1. Therefore, a graph of FIG. 10 indicates characteristic having a closed area A2. When the value of the relative rotational angle θ 1 is the angle value θ a, the minimum value of the load torque T1 is Ta1, and the maximum value of the load torque T1 is Ta2.

Also, an angle value θ b is the maximum relative rotational angle θ 1 upon the power transmission by both the power transmitting arms 51 and 52, that is, upon engaging both the engaging recesses 51a and 52a with the respective rollers 49. When the value of the relative rotational angle θ 1 is the angle value θ b, the value of the load torque T1 is a torque value Tb.

The arms 51 and 52 are configured such that the value of the load torque T1 tends to increase nonlinearly smoothly to the torque value Tb via the torque value Ta2 when the value of the relative rotational angle θ 1 continuously increases from zero.

Also, when the value of the relative rotational angle θ 1 continuously reduces from θ b, the value of the load torque T1 tends to reduce nonlinearly smoothly from the torque value Tb to zero via the torque value Ta1.

In this manner, in the present embodiment, the load torque T1 (transmission torque) is configured to continuously vary with the relative rotational angle θ 1.

Meanwhile, upon actual rotation of the drive shaft 16, reactive force due to compressing refrigerant gas and reactive force due to reciprocation of the piston 21 transmit to the drive shaft 16 through the swash plate 18 and the hinge mechanism 19. Thereby, twisting vibration is generated on the drive shaft 16. The twisting vibration generates torque variation (variation of the load torque). The torque variation causes resonance to arise at the compressor C itself and between the compressor C and an external rotary components, such as the engine E and an auxiliary machine, which connect with the compressor C through the pulley 42 and the belt 33.

The torque variation arises to increase and reduce torque values by equal torque amplitude relative to its average torque value. Also, the average torque value is approximately constant irrespective of the rotational speed V of the drive shaft 16. In the present embodiment, the elastic body is tuned such that the intermediate value between the torque values Ta1 and Ta2, that is, (Ta1+Ta2)/2, equals the average torque value.

Also, a peak of the torque variation (a peak of the amplitude of the variation) arises when natural frequency of the elastic body equals twisting vibration of the drive shaft 16. Besides, frequency of the twisting vibration of the drive shaft 16 is directly proportional to the rotational speed V of the drive shaft 16.

In the present embodiment, when the value of the rotational speed V continuously increases from zero, frequency of the twisting vibration approaches the natural frequency of the first power transmitting arms 51 themselves, and the amplitude of the torque variation increases to a predetermined value (a predetermined amplitude of vibration Wa), the power transmission by the elastic body is configured to switch from the power transmission only by the power transmitting arms 51 to the power transmission by both the arms 51 and 52.

Also, when the value of the rotational speed V further increases, frequency of the twisting vibration approaches the natural frequency of the total elastic body constituted of the arms 51 and 52, and the amplitude of the torque variation increases to the predetermined value (the predetermined amplitude of vibration Wa), the power transmission by the elastic body is configured to switch from the power transmission by both the arms 51 and 52 to the power transmission only by the power transmitting arms 51.

This can be performed when the arms 51 and 52 are tuned such that differential (Ta2−Ta1)/2 between the torque value Ta1 or Ta2 and the average torque value of the torque variation (Ta1+Ta2)/2 equals the predetermined amplitude of variation Wa.

Namely, when the value of the rotational speed V continuously increases from zero, the natural frequency of the elastic member approaches the frequency of twisting vibration of the drive shaft 16. Thereby, the amplitude of the torque variation increases. When the amplitude of the torque variation increases to equal the torque value differential (Ta2−Ta1)/2, the value of the relative rotational angle θ 1 reaches the angle value θ a. Therefore, the elastic body indicates a characteristic due to cooperative action, and the characteristic is different from that of only the first power transmitting arms 51. In this manner, since the natural frequency of the elastic body varies, the amplitude of the torque variation of the total elastic body tends to reduce upon starting the cooperative action by the arms 51 and 52. Therefore, the value of the load torque T1 indicates a value that is relatively closer to the average torque value of the torque variation. In such a state, since the value of the load torque T1 varies in the range of a closed area A2 in a graph of FIG. 10, in the elastic body, cooperative action by the arms 51 and 52 continues.

When the value of the rotational speed V further continuously increases, the natural frequency of the elastic body in a state of cooperative action by the arms 51 and 52 approaches the frequency of twisting vibration of the drive shaft 16. Thereby, the amplitude of the torque variation increases. When the amplitude of the torque variation increases to exceed the torque value differential (Ta2−Ta1)/2, the value of the load torque T1 becomes lower than the torque value Ta1, and the value of the relative rotational angle θ 1 becomes lower than the angle value θ a. Therefore, the elastic body is switched from cooperative action by the arms 51 and 52 to single action only by the first power transmitting arms 51. Namely, the amplitude of the torque variation of the elastic body tends to reduce upon switching, and the value of the load torque T1 indicates a relatively much closer value to the average torque value of the torque variation.

Accordingly, in the power transmitting mechanism PT of the present embodiment, the amplitude of the torque variation is effectively reduced when the engine E rotates at relatively low speed, which is frequently utilized in a practical use, and when the engine E rotates at relatively high speed, which affects durability of the engine E.

In the present embodiment, when the load torque T1 does not affect the engine E, that is, when the value of the torque load T1 is below the torque value Tb, at least one pair of the engaging recesses 51a and 52a engages with the respective rollers 49. Thereby, the power transmission from the engine E to the drive shaft 16 is maintained.

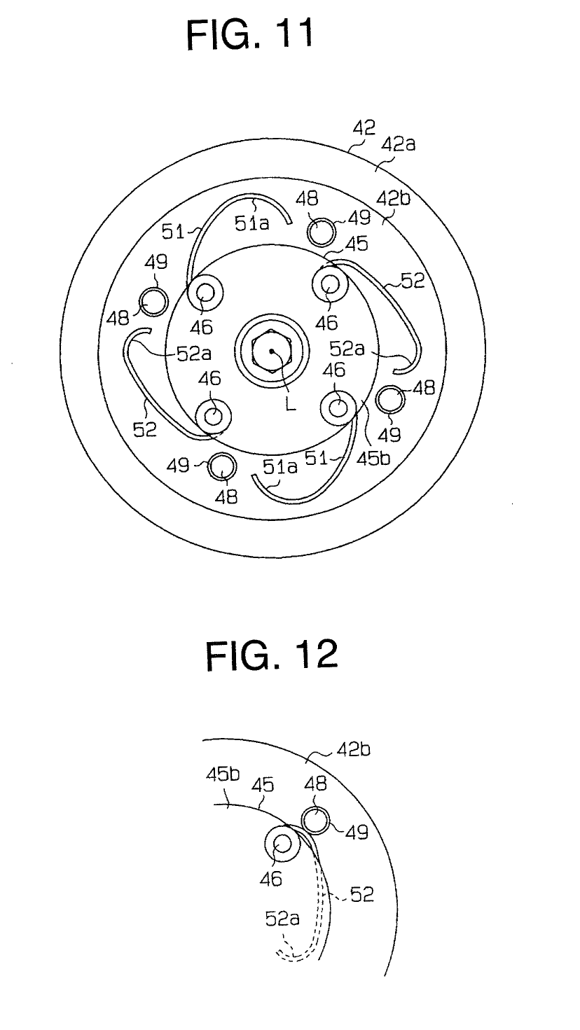

When the value of the load torque T1 exceeds the torque value Tb due to abnormality such as dead lock on the compressor C, elastic force of the arms 51 and 52 cannot maintain to engage the arms 51 and 52 with the respective rollers 49. Namely, the rollers 49 overpass the respective engaging recesses 51a and 52a toward the respective arms 51 and 52, and the rollers 49 disengage from the respective arms 51 and 52. Thereby, the power transmission from the pulley 42 to the receiving member 45 is blocked, as shown in FIG. 11. In this manner, excessive load torque T1 above the torque value Tb is inhibited from affecting the engine E.

When the rollers 49 disengage from the arms 51 and 52, the rollers 49 on the pulley 42 abut against the outer side (the opposite side of the respective engaging recesses 51a and 52a) of the arms 51 and 52 on their locus due to free relative rotation of the pulley 42 relative to the receiving member 45. Namely, since the arms 51 and 52 abut against the respective rollers 49, rotational force with respect to the support pins 46 acts on each of the arms 51 and 52. Then, the arms 51 and 52 together with the associated sleeves 47 are rotated clockwise around the support pins 46, as shown in FIG. 12. Consequently, the arms 51 and 52 are located at retreated positions so as not to engage with the rollers 49. Besides, in FIG. 12, only one of the second power transmitting arms 52 is shown, and the first power transmitting arms 51 are omitted.

Also, since the sleeves 47 are press-fitted to the support pins 46 by appropriate force, even if external force such as force due to vibration of the vehicle acts on the sleeves 47, the sleeves 47 maintain the arms 51 and 52 at the retreated positions. Thereby, the following rollers 49 do not interfere with the arms 51 and 52, and noise and vibration are inhibited from arising due to repeat of the interference.

When power is transmitted between the pulley 42 and the receiving member 45, and when the torque variation arises, abutting points between the rollers 49 and the respective engaging recesses 51a and 52a repeatedly vary with the torque variation. Namely, the pulley 42 rotates relative to the receiving member 45 alternatively repeatedly clockwise and counterclockwise in a predetermined angle range. Thereby, variation of transmission torque between the pulley 42 and the receiving member 45 is relieved.

Additionally, the compressor C in the present embodiment is configured to vary its displacement, and the load torque T1 varies with the displacement. However, the foregoing predetermined values on the power transmitting mechanism PT for inhibiting resonance are determined in view of the displacement of the compressor C upon normal operation.

The following advantageous effects are obtained from the present embodiment.

(5) Since the load torque T1 continuously varies with the relative rotational angle θ 1 between the pulley 42 and the receiving member 45, resonance between the pulley 42 and the receiving member 45 are inhibited from arising.

(6) The elastic body constituted of the arms 51 and 52 is configured to increase the number of the acting elastic members when the value of the relative rotational angle θ 1 between the pulley 42 and the receiving member 45 is a predetermined value or above. Thereby, permissible range of the load torque T1 can easily be widened.

(7) The arms 51 and 52 are made of plate spring. Thereby, the elastic members are easily manufactured. Therefore, manufacturing cost is reduced.

The present invention is not limited to the embodiments described above, but may be modified into the following examples.

In the first embodiment, the layered plate springs 36 and 37 are located on the pulley 32, and the engaging projections 35c are formed on the receiving member 35. On the contrary, the power transmission may be permitted by engaging the engaging projection, which is formed on the pulley, with the layered plate springs, which are located on the receiving member.

In the first embodiment, for example, as shown in FIG. 5, the inner wall surfaces 32e and 32f may form grooves 39, and the grooves 39 may accommodate each end of the layered plate springs 36 and 37. Thereby, upon separating from the engaging projection 35c, the plate springs 36 and 37 are maintained without unnecessary movement.

In the first embodiment, the layered plate springs 37 are employed as a means for urging the engaging projections 35c to abut against the layered plate springs 36. However, the urging means is not limited. As far as the urging means has urging function, the urging means other than the plate spring may be employed. For example, a coil spring or a wired spring may be employed.

In the first embodiment, the layered plate springs 37 are located at the opposite side of the layered plate springs 36 relative to the engaging projection 35c. However, the layered plate springs 37 may be omitted.

In the first embodiment, the layered plate springs 36 and 37 are bilateral support springs, each end of which is supported. However, single support springs, only one end of which is supported, may be employed.

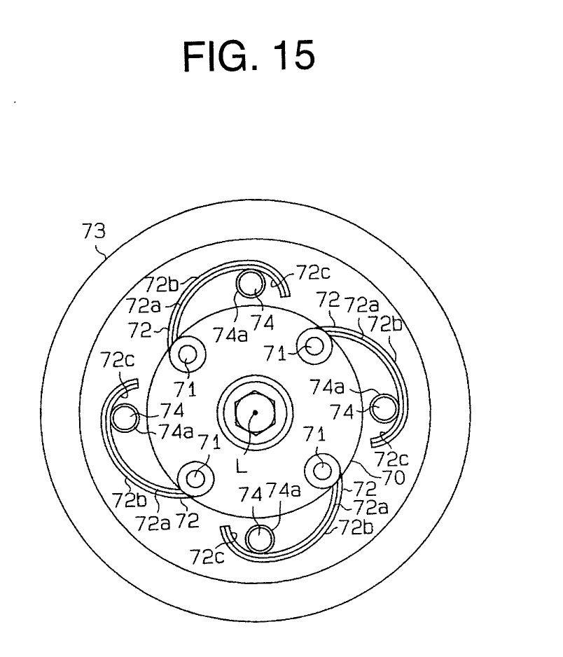

In the first embodiment, power is transmitted from the pulley 32 to the receiving member 35 by engaging the layered plate springs 36, which are accommodated in the respective recesses 32c of the pulley 32, with the engaging projections 35c of the receiving member 35. On the contrary, for example, as shown in FIG. 15, the proximal ends of elastic bodies 72 may be supported by respective support portions 71 on a receiving member 70 or a first rotary body, and the distal ends of the elastic bodies 72 may engage with respective engaging projections 74 on a pulley 73 or a second rotary body. Thereby, the power transmission from the pulley 73 to the receiving member 70 may be permitted. The receiving member 70 is fixed to the drive shaft 16 (not shown in FIG. 15) so as to rotate integrally. The pulley 73 is arranged coaxially with the receiving member 70, and is configured to rotate relative to the receiving member 70. The elastic bodies 72 are supported to rotate relative to the respective support portions 71. Each elastic body 72 is constituted of power transmitting arms 72a and 72b or elastic members made of layered plate springs. Each pair of power transmitting arms 72a and 72b curves toward the power transmitting arm 72a side so as to directly engage with the respective engaging projection 74 (concretely, a roller 74a or a rolling component rotatably provided around the engaging projection 74) when the power transmission is permitted. Namely, the distal ends of the power transmitting arms 72a form engaging recesses 72c to transmit power by engaging with the associated engaging projections 74. The coefficient of elasticity of the elastic bodies 72 are tuned to continuously vary with a relative rotational angle between the receiving member 70 and the pulley 73. In this manner, resonance between the receiving member 70 and the pulley 73 is also inhibited from arising.

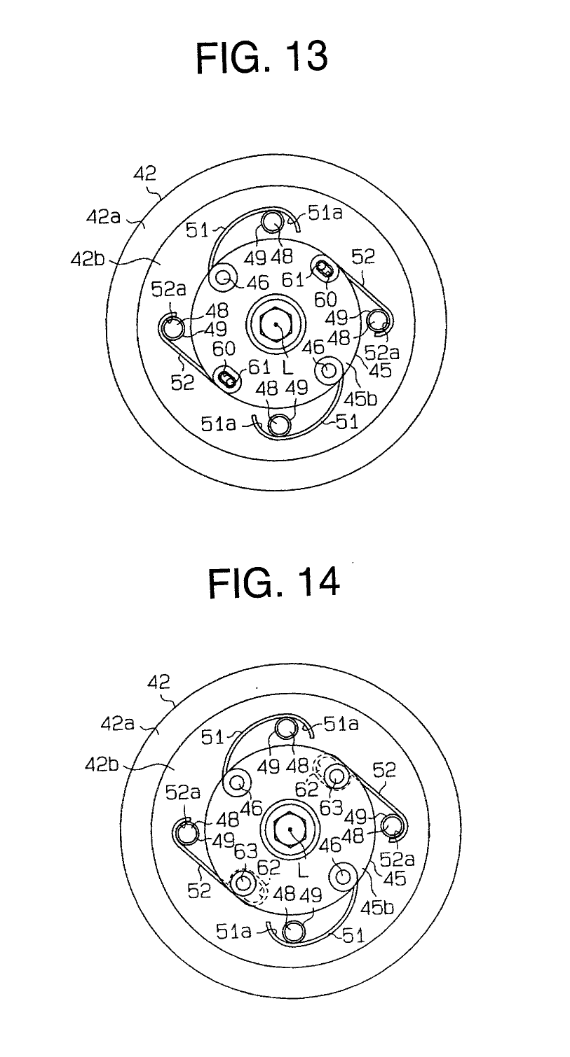

In the second embodiment, when the value of the relative rotational angle θ 1 is below the predetermined angle value θ a, the engaging recesses 52a of the second power transmitting arms 52 cannot engage with the associated rollers 49. On the contrary, the proximal ends of the second power transmitting arms 52 may be assembled to rotate relative to the support portions on the hub 45b and to move in the circumferential direction of the hub 45b. Thereby, even if the value of the relative rotational angle θ 1 is below the predetermined angle value θ a, the engaging recesses 52a can engage with the respective rollers 49. In such a state, for example, as shown in FIG. 13, the hub 45b may form oblong holes 60 or the support portions, and engaging pins 61 provided at the proximal ends of the power transmitting arms 52 may fit into the associated oblong holes 60. Also, for example, as shown in FIG. 14, the proximal ends of the power transmitting arms 52 include oblong-shaped portions 62, and pins 63 or support portions extending from the hub 45b may fit into the associated oblong-shaped portions 62.

In the second embodiment, each of the support pins 46 supports one of the first power transmitting arm 51 and the second power transmitting arm 52. However, each of the support pins 46 may support both of the arms 51 and 52.

In the second embodiment, when excessive load torque T1 is applied between the pulley 42 and the receiving member 45, the power transmission therebetween is blocked. However, the function for blocking the power transmission may be omitted.

In the present embodiment, the proximal ends of the arms 51 and 52 are supported at the receiving member 45 side, and the distal ends of the arms 51 and 52 engage with the pulley 42 side. On the contrary, the support portions may be provided on the pulley side, and the proximal ends of the arms 51 and 52 may be supported by the support portions, and then the distal ends of the arms 51 and 52 may engage with engaging portions on the receiving member.

In the above-described embodiments, each of the elastic members 36, 37, 51 and 52 are made of plate springs. However, as far as members have elasticity, the elastic members may be made of materials other than the plate springs. For example, the pulley may connect with the receiving member through a coil spring or a wired spring.

In the above-described embodiments, the compressor C is a single-headed piston type, which compresses gas by single-headed pistons. However, the compressor C may be a double-headed piston type, which compresses refrigerant gas by double-headed pistons in respective cylinder bores on each side of its crank chamber.

In the above-described embodiments, the operation of the compressor that compresses refrigerant gas is described. However, the compressor is not limited to the compressor that compresses refrigerant gas. A compressor that compresses gas or fluid may be employed.

In the above-described embodiments, the compressor C is a swash plate type, which includes the swash plate 18 or a cam plate integrally rotating with the drive shaft 16. However, the compressor C may be a wobble plate type, which includes a cam plate supported to relatively rotate to the drive shaft.

The compressor C may be a fixed displacement type, which does not permit stroke of the piston 21 to vary.

In the above-described embodiments, a piston type compressor, which reciprocates pistons, is employed. However, a rotary type compressor such as a scroll type compressor may be employed.

In the above-described embodiments, the present invention is applied to the compressor. However, as far as a rotary machine includes a receiving member and a drive shaft fixed coaxially with the receiving member, and twisting vibration may arise on the drive shaft, any rotary machine may be employed.

In the above-described embodiments, a sprocket wheel or a gear may be employed as the second rotary body in place of the pulley.

Therefore, the present examples and embodiments are to be considered as illustrative and not restrictive and the invention is not to be limited to the details given herein but may be modified within the scope of the appended claims.

What is claimed is:

1. A power transmitting mechanism comprising:
a first rotary body having a plurality of first elastic members, the first elastic members being layered; and
a second rotary body arranged coaxially with the first rotary body, the second rotary body having an engaging portion for engaging with the layered first elastic members to permit power transmission between the first rotary body and the second rotary body;
wherein the coefficient of elasticity of the layered first elastic members continuously varies with a relative rotational angle between the first rotary body and the second rotary body.

2. The power transmitting mechanism according to claim 1, wherein the layered first elastic members are layered bilateral support plate springs, which are arranged to align in the circumferential direction of the first rotary body.

3. The power transmitting mechanism according to claim 2, wherein the first rotary body forms a recess to accommodate the layered bilateral support plate springs, and a distance between support points on the inner wall surface of the recess varies with the layered bilateral support plate springs sliding along the inner wall surface upon the power transmission between the first rotary body and the second rotary body.

4. The power transmitting mechanism according to claim 1 further comprising:
urging means for urging the engaging portion to abut against the layered first elastic members.

5. The power transmitting mechanism according to claim 4, wherein the urging means for urging the engaging portion is another layered elastic members.

6. The power transmitting mechanism according to claim 1, wherein the first rotary body has a plurality of second elastic members, the second elastic members are layered, and the layered second elastic members are arranged at the opposite side of the layered first elastic members relative to the engaging portion.

7. The power transmitting mechanism according to claim 6, wherein the layered first elastic members and the layered second elastic members each receive and urge the engaging portion upon the power transmission between the first rotary body and the second rotary body.

8. The power transmitting mechanism according to claim 1, wherein the first rotary body has an engaging recess, a groove for accommodating each end of the layered first elastic members is formed on an inner surface of the engaging recess.

9. A power transmitting mechanism comprising:
a first rotary body; and
a second rotary body arranged coaxially with the first rotary body, one of the first rotary body and the second rotary body having a plurality of elastic members, each of which has a first engaging portion, the other of the first rotary body and the second rotary body having a second engaging portion for engaging with the first engaging portion to permit power transmission between the first rotary body and the second rotary body,
wherein one of the first engaging portion and the second engaging portion is projection, and the other is recess,
wherein the first engaging portion is configured so as to change its position relative to the first rotary body in accordance with deformation of the elastic members due to transmission torque between the first rotary body and the second rotary body, to permit the first rotary body and the second rotary body to rotate relative to each other in accordance with the engaging projection sliding along a sliding surface of the engaging recess, and
wherein the number of the operative elastic members increases when the value of a relative rotational angle between the first rotary body and the second rotary body exceeds a predetermined value, so that variation in the transmission torque continuously varies with variation in the relative rotational angle.

10. The power transmitting mechanism according to claim 9, wherein the number of the first engaging portions that engage with the second engaging portions increases when the value of the relative rotational angle exceeds the predetermined value.

11. The power transmitting mechanism according to claim 9, wherein the elastic members are made of plate springs.

12. A compressor operatively connected to an external drive source, the compressor comprising:
a compression mechanism having a drive shaft for compressing fluid;
a pulley operatively connected to the external drive source; and
a receiving member connected to the drive shaft, the receiving member arranged coaxially with the pulley,
wherein one of the pulley and the receiving member has layered first elastic members, and the other has an engaging portion for engaging with the layered first elastic members to permit power transmission between the pulley and the receiving member, and
wherein the coefficient of elasticity of the layered first elastic members continuously varies with a relative rotational angle between the pulley and the receiving member.

13. The compressor according to claim 12, wherein the compressor is a piston type.

14. The compressor according to claim 13, wherein the compressor is a swash plate type.

15. The compressor according to claim 12, wherein the compressor is a variable displacement type.

16. The compressor according to claim 12, wherein the fluid is refrigerant gas.

17. A compressor operatively connected to an external drive source, the compressor comprising:
a compression mechanism having a drive shaft for compressing fluid;
a pulley operatively connected to the external drive source; and
a receiving member connected to the drive shaft, the receiving member arranged coaxially with the pulley, one of the pulley and the receiving member having a plurality of elastic members, each of which has a first engaging portion, the other of the pulley and the receiving member having a second engaging portion for engaging with the first engaging portion to permit power transmission between the pulley and the receiving member,
wherein one of the first engaging portion and the second engaging portion is projection, and the other is recess,
wherein the first engaging portion is configured so as to change its position relative to the pulley in accordance with deformation of the elastic members due to transmission torque between the pulley and the receiving member, whereby permitting the pulley and the receiving member to rotate relative to each other in accordance with the engaging projection sliding along a sliding surface of the engaging recess, and
wherein the number of the operative elastic members increases when the value of a relative rotational angle between the pulley and the receiving member exceeds a predetermined value, whereby variation in the transmission torque continuously varies with variation in the relative rotational angle.

18. The compressor according to claim 17, wherein the fluid is refrigerant gas.
